(19) United States
(12) Patent Application Publication
(10) Pub. No.: US 2015/0272815 A1
(43) Pub. Date: Oct. 1, 2015

(54) Therapeutic Garment Assembly

(71) Applicant: David R. Kitchens, Martinez, GA (US)

(72) Inventor: David R. Kitchens, Martinez, GA (US)

(21) Appl. No.: 14/224,275

(22) Filed: Mar. 25, 2014

(51) Int. Cl. A61H 23/00; A61H 1/00

(52) U.S. Cl. CPC A61H 23/00; A61H 1/008; A61H 2201/0107

(57) ABSTRACT

A therapeutic garment assembly for providing relief from restless leg syndrome includes a sock that is worn on a user's leg. A pocket is coupled to the sock. A vibrating member is positionable within the pocket. The vibrating member provides tactile stimulation to the user's legs. The vibrating member alleviates a symptom of restless leg syndrome.

### BACKGROUND OF THE DISCLOSURE

### Field of the Disclosure

The disclosure relates to therapeutic garment devices and more particularly pertains to a new therapeutic garment device for providing relief from restless leg syndrome.

### SUMMARY OF THE DISCLOSURE

An embodiment of the disclosure meets the needs presented above by generally comprising a sock that is worn on a user's leg. A pocket is coupled to the sock. A vibrating member is positionable within the pocket. The vibrating member provides tactile stimulation to the user's legs. The vibrating member alleviates a symptom of restless leg syndrome.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a therapeutic garment assembly according to an embodiment of the disclosure.

FIG. 2 is a left side view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is an in-use view of an embodiment of the disclosure.

### DESCRIPTION OF THE PREFERRED EMBODIMENT

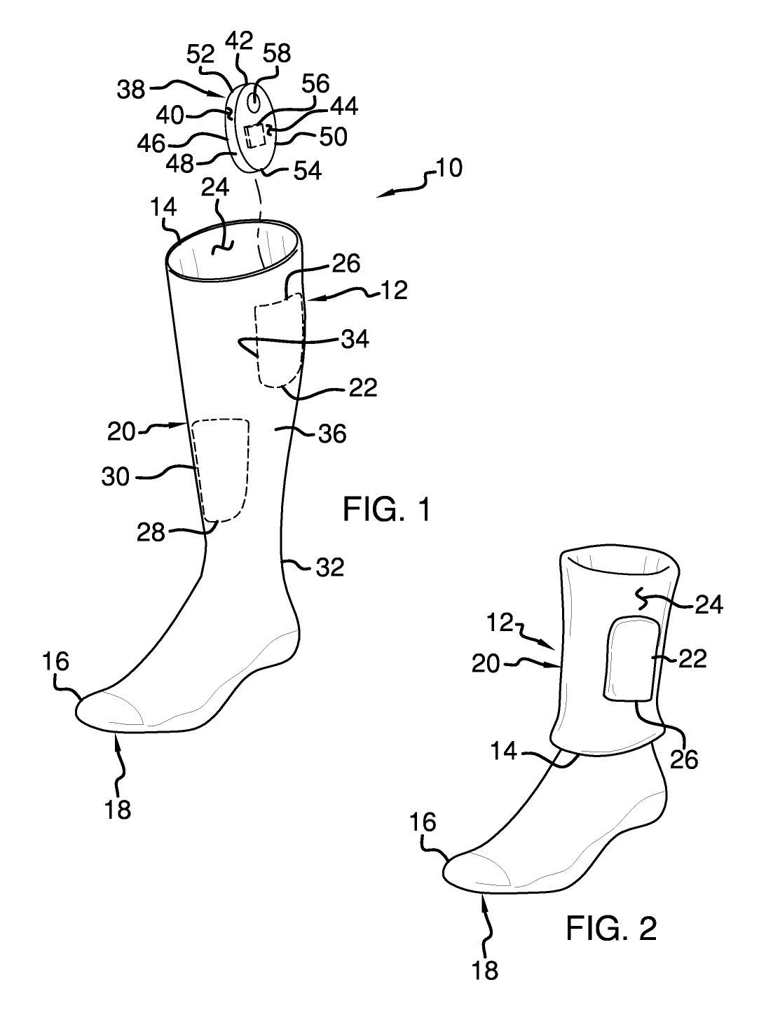

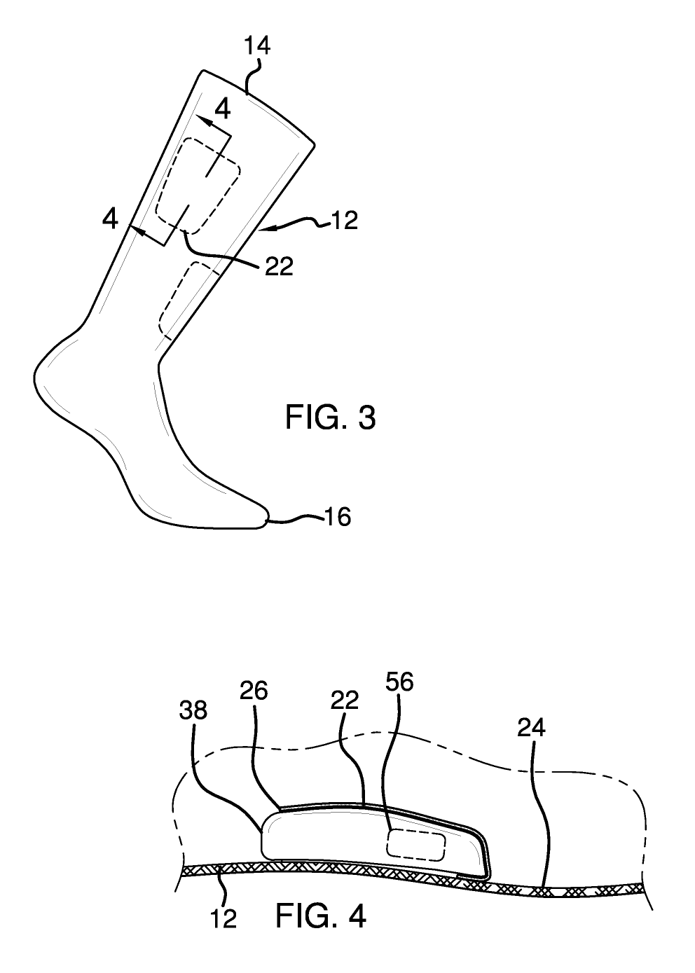

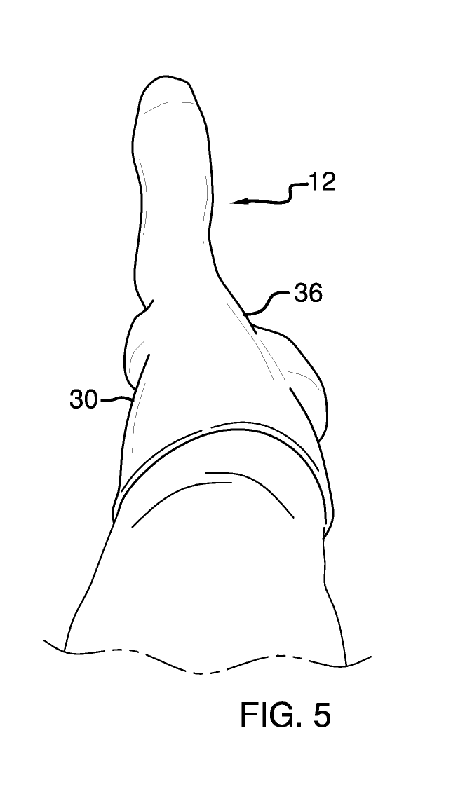

With reference now to the drawings, and in particular to FIGS. 1 through 5 thereof, a new therapeutic garment device embodying the principles and concepts of an embodiment of the disclosure and generally designated by the reference numeral 10 will be described.

As best illustrated in FIGS. 1 through 5, the therapeutic garment assembly 10 generally comprises sock 12 each comprising a body end 14 and a toe end 16. The body end 14 of the sock 12 is open. Additionally, the sock 12 is elongated between the body 14 and toe ends 16. The body end 14 of the sock 12 insertably receives an associated one of the user's leg so the user's toes are positioned within a toe 18 of the sock 12 and a body 20 of the sock 12 extends upwardly along the associated one of user's lower legs. The sock 12 may be comprised of a resiliently stretchable material.

A pocket 22 is coupled to an inside surface 24 of the body 20 of the sock 12. The pocket 22 has a top end 26 that is open. Moreover, the pocket 22 is one of a pair of the pockets 22. A first one of the pair of pockets 28 is positioned on a second lateral side 30 of the body 20 of the sock 12 proximate a lower end 32 of the body 20 of the sock 12. A second one of the pair of pockets 34 is positioned on a first lateral side 36 of the body 20 of the sock 12 proximate the body end 14 of the sock 12. Each of the first 28 and second 34 pockets may be comprised of a resiliently stretchable material.

A vibrating member 38 is provided. An oblique surface 40 of an outer wall 42 of the vibrating member 38 extends between a top surface 44 and a bottom surface 46 of the outer wall 42 of the vibrating member 38. Each of a first flanking side 48 and a second flanking side 50 of the oblique surface 40 of the outer wall 42 of the vibrating member 38 curves outwardly between a front end 52 and a back end 54 of the vibrating member 38. The vibrating member 38 has an ovoid cross section taken perpendicular to a line extending through the top 44 and bottom 46 surfaces of the outer wall 42 of the vibrating member 38. The vibrating member 38 may have a length between 7 cm and 10 cm.

A vibrator 56 is coupled to the vibrating member 38. The vibrator 56 engages the outer wall 42 of the vibrating member 38. Moreover, the vibrator 56 vibrates the vibrating member 38. The vibrator 56 may be a centrifugal vibrator of any conventional design.

An actuator 58 is coupled to the top surface 44 of the outer wall 42 of the vibrating member 38. The actuator 58 is electrically coupled to the vibrator 56 so the actuator 58 selectively actuates and de-actuates the vibrator 56. The vibrating member 38 is one of a pair of the vibrating members 38. Each of the pair of vibrating members 38 is positionable within an associated one of the first 28 and second 34 pockets.

The sock 12 is one of a pair of the socks 12. Each of the pair of socks 12 is worn on an associated one of each of the user's legs. The pair of vibrating members 38 in each of the pair of socks 12 provides tactile stimulation to each of the user's legs. Additionally, the pair of vibrating members 38 alleviates a symptom of restless leg syndrome.

In use, the pair of socks 12 are worn by the user prior to going to sleep. The pair of vibrating members 38 in each of the pair of socks 12 are actuated. Additionally, each of the vibrating members 38 vibrates against the user's legs. The constant vibration alleviates the user's need to continually move the user's legs while the user attempts to sleep. Finally, the pair of socks 12 can be worn while the user is awake.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A therapeutic garment assembly configured to contain a vibrating member, said assembly being worn by a user to provide relief from restless leg syndrome, said assembly comprising:
a sock being worn on the user's leg;
a pocket coupled to said sock; and
said vibrating member being positionable within said pocket such that said vibrating member provides tactile stimulation to the user's legs, said vibrating member alleviating a symptom of restless leg syndrome.

2. The assembly according to claim 1, wherein said sock comprising a body end and a toe end, said body end of said sock being open, said sock being elongated between said body and toe ends.

3. The assembly according to claim 1, wherein a body end of said sock insertably receiving the user's leg such that the user's toes are positioned within a toe of said sock and a body of said sock extends upwardly along the user's lower leg.

4. The assembly according to claim 1, wherein said pocket being coupled to an inside surface of a body of said sock, said pocket having an top end being open.

5. The assembly according to claim 1, wherein said pocket being one of a pair of said pockets.

6. The assembly according to claim 5, wherein a first one of said pair of pockets being positioned on a second lateral side of a body of said sock proximate a lower end of said body of said sock.

7. The assembly according to claim 5, wherein a second one of said pair of pockets being positioned on a first lateral side of said body of said sock proximate a body end of said sock.

8. The assembly according to claim 1, wherein said vibrating member having an oblique surface of an outer wall of said vibrating member extending between a top surface and a bottom surface of said outer wall of said vibrating member.

9. The assembly according to claim 1, wherein each of a first flanking side and a second flanking side of an oblique surface of an outer wall of said vibrating member curving outwardly between a front end and a back end of said vibrating member such that said vibrating member has an ovoid cross section taken perpendicular to a line extending through a top surface and a bottom surface of said outer wall of said vibrating member.

10. The assembly according to claim 1, wherein a vibrator coupled to said vibrating member, said vibrator engaging an outer wall of said vibrating member such that said vibrator vibrates said vibrating member.

11. The assembly according to claim 1, wherein an actuator coupled to a top surface of an outer wall of said vibrating member, said actuator being electrically coupled to said vibrator such that said actuator selectively actuates and de-actuates said vibrator.

12. The assembly according to claim 1, wherein said vibrating member being one of a pair of said vibrating members.

13. The assembly according to claim 12, wherein each of said pair of vibrating members being positionable within an associated one of a first one and a second one of a pair of said pockets.

14. A therapeutic garment assembly configured to contain a vibrating member, said assembly being worn by a user to provide relief from restless leg syndrome, said assembly comprising:
a sock comprising a body end and a toe end, said body end of said sock being open, said sock being elongated between said body and toe ends, said body end of said sock insertably receiving one of the user's leg such that the user's toes are positioned within a toe of said sock and a body of said sock extends upwardly along the user's lower leg;
a pocket coupled to an inside surface of said body of said sock, said pocket having a top end being open;
said pocket being one of a pair of said pockets;
a first one of said pair of pockets being positioned on a second lateral side of said body of said sock proximate a lower end of said body of said sock;
a second one of said pair of pockets being positioned on a first lateral side of said body of said sock proximate said body end of said sock;
said vibrating member having an oblique surface of an outer wall of said vibrating member extending between a top surface and a bottom surface of said outer wall of said vibrating member, each of a first flanking side and a second flanking side of said oblique surface of said outer wall of said vibrating member curving outwardly between a front end and a back end of said vibrating member such that said vibrating member has an ovoid cross section taken perpendicular to a line extending through said top and bottom surfaces of said outer wall of said vibrating member;
a vibrator coupled to said vibrating member, said vibrator engaging said outer wall of said vibrating member such that said vibrator vibrates said vibrating member;
an actuator coupled to said top surface of said outer wall of said vibrating member, said actuator being electrically coupled to said vibrator such that said actuator selectively actuates and de-actuates said vibrator;
said vibrating member being one of a pair of said vibrating members; and
each of said pair of vibrating members being positionable within an associated one of said first and second pockets such that said pair of vibrating members provides tactile stimulation to the user's legs, said pair of vibrating members alleviating a symptom of restless leg syndrome.
